(19) United States
(12) Patent Application Publication
(10) Pub. No.: US 2025/0286685 A1
(43) Pub. Date: Sep. 11, 2025

(54) TECHNIQUES FOR SIDELINK POSITIONING

(71) Applicant: NEC Corporation, Minato-ku, Tokyo (JP)

(72) Inventor: Yinan QI, Tokyo (JP)

(73) Assignee: NEC Corporation, Minato-ku, Tokyo (JP)

(21) Appl. No.: 18/860,758

(22) PCT Filed: Apr. 24, 2023
(86) PCT No.: PCT/JP2023/016045

§ 371 Date: Oct. 28, 2024

(30) Foreign Application Priority Data
May 6, 2022 (GB) 2206699.7

(51) Int. Cl. H04L 5/00; H04W 72/25

(52) U.S. Cl. CPC H04L 5/0051; H04W 72/25

(57) ABSTRACT

A system (1) is disclosed in which a user equipment (UE) (3) is configured for UE-to-UE direct communication. The UE (3) receives, from a network node (5), information for determining a resource for transmission of a positioning reference signal for another UE (3), and transmits the positioning reference signal using a resource which is determined based on using the information.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to positioning of user equipment (UE) in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication between the UEs and the base station is controlled using the so-called Radio Resource Control (RRC) protocol. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 (NPL 1).

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 (NPL 2) and 3GPP TS 37.340 V16.7.0 (NPL 3) define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

The term base station or RAN node is used herein to refer to any such node.

The 3GPP standards also specify various ways in which UEs can communicate data between each other without using resources of a base station (although in some cases the UEs will require at least some control signalling from the base station). Such communications are generally referred to as UE-to-UE direct communications or Device-to-Device (D2D) communications. D2D communications were originally defined as part of Proximity Services (ProSe) services in Release 12 and Release 13 of the specifications. As part of ProSe services, a new D2D interface was introduced. This D2D interface is referred to as ‘PC5’, or ‘Sidelink’ at the physical layer. Sidelink provides a direct link for communications between devices, with or without network coverage. Sidelink has been enhanced for vehicular use cases, addressing high speed (up to 250 km/h along roads and up to 500 km/h along railways) and high density (thousands of nodes) scenarios as well.

Sidelink has several application areas, such as proximity services, public safety, IoT, including machine type communication and sensors, wearable devices, amongst others. The term Vehicle-to-Everything (V2X) covers a special application area of Sidelink/PC5 for the purpose of communications between vehicles using a direct link. V2X encompasses at least the following categories: Vehicle-to-Vehicle (V2V); Vehicle-to-Infrastructure (V21); Vehicle-to-Pedestrian (V2P); Vehicle-to-Home (V2H); and enhanced Vehicle-to-Everything (eV2X).

An important aspect of D2D, especially in case of V2X, is the positioning of UEs (vehicles). V2X positioning requirements can be found in 3GPP TS 22.261 V17.10.0 (NPL 4) and 3GPP TS 22.186 V17.0.0 (NPL 5). 3GPP TS 22.261 (NPL 4) specifies the high accuracy positioning requirements for the 5G system and these requirements are summarized in its Clause 7.3.2.2 with a note that these requirements include V2X. Seven different positioning service levels are defined in Table 7.3.2.2-1 of 3GPP TS 22.261 (NPL 4) in terms of horizontal and vertical accuracy, positioning service availability, and positioning service latency. 3GPP TS 22.186 (NPL 5) specifies the relative lateral positioning requirement for general V2X use cases and the relative longitudinal positioning requirement.

### CITATION LIST

### Non Patent Literature

NPL 1: ‘NGMN 5G White Paper’ V1.0, the Next Generation Mobile Networks (NGMN) Alliance, February 2015, https://ngmn.org/wp-content/uploads/NGMN_5G_White_Paper_V1_0.pdf
NPL 2: 3GPP TS 38.300, “NR; NR and NG-RAN Overall Description; Stage 2”, V16.7.0 (2021-09)
NPL 3: 3GPP TS 37.340, “Evolved Universal Terrestrial Radio Access (E-UTRA) and NR; Multi-connectivity; Stage 2”, V16.7.0 (2021-09)
NPL 4: 3GPP TS 22.261, “Service requirements for the 5G system; Stage 1”, V17.10.0 (2022-03)
NPL 5: 3GPP TS 22.186, “Enhancement of 3GPP support for V2X scenarios; Stage 1”, V17.0.0 (2022-03)
NPL 6: 5G Automotive Association (5GAA), “LS reply to 3GPP RAN on requirements of in-coverage, partial coverage, and out-of-coverage positioning use cases”, 3GPP TSG RAN Meeting #91e, RP-210040, Electronic Meeting, March 2021
NPL 7: 3GPP TR 38.845, “Study on scenarios and requirements of in-coverage, partial coverage, and out-of-coverage NR positioning use cases”, V17.0.0 (2021-09)
NPL 8: 3GPP TS 38.211, “NR; Physical channels and modulation”, V17.0.0 (2021-12)
NPL 9: 3GPP TS 22.368, “Service requirements for Machine-Type Communications (MTC); Stage 1”, V13.1.0 (2014-12)

### SUMMARY OF INVENTION

### Technical Problem

The 5G Automotive Association (5GAA) provides positioning requirements for various V2X services allocated into three groups; the first group with tens of meters accuracy (e.g. for information provisioning), the second group with lane level accuracy (e.g. for safety use cases), and the third group with sub-meter level accuracy (e.g. for automated driving or teleoperated driving). The positioning requirements can be on the 3D/2D coordinates (absolute position) or on the distance and/or angle (relative position) to a anchor node, e.g. another UE.

Further details may be found in 3GPP document no. RP-210040 (NPL 6). However, sidelink has not been used for positioning before and the inventors have identified a number of issues relating to sidelink positioning. It should be noted that the following terminology is used in this document:
anchor UE: a UE used as an anchor node to locate another UE;
anchor node: a network element used as an anchor node to locate another network node;
target UE: a UE whose location is unknown and needs to be located;
target node: a network element whose location is unknown and needs to be located;
S-PRS: sidelink positioning reference signals, i.e., positioning reference signals transmitted/received in the slidelink and used for positioning purpose.

One issue of sidelink positioning is that the location change of moving anchor nodes during the entire positioning procedure will affect the positioning accuracy, especially for use cases/scenarios that require sub-meter accuracy.

When a UE is out-of-coverage of any base station, the UE applies autonomous resource allocation, which is determined through a sensing procedure conducted autonomously by the transmitting UE. In such a case, the UE selects an appropriate amount of resources randomly and the resources selected are not in general periodic which may cause problems in sidelink positioning.

Moreover, the currently defined slot format for sidelink is not suitable for transmitting positioning reference signals (PRS) since some symbols may carry special information that may interfere with PRS.

Positioning reference signals may be transmitted using licensed bands and the so-called Intelligent Transport Systems (ITS) band. The available ITS bandwidth is less than 80 MHz and in some countries only 20 MHz is allocated to ITS. Since positioning accuracy is related to the PRS bandwidth (a large bandwidth is needed to achieve high accuracy such as sub-meter accuracy), the ITS spectrum may not be able to provide sufficient accuracy when timing difference based positioning methods are used.

Another issue is that the power of a PRS received from an anchor UE may be significantly lower than the power of a PRS received from serving or adjacent base stations, even when the anchor UE is located closer than the base stations. This difference in power may cause interference and it may limit which anchor nodes can be used by the UE for sidelink positioning. It may also affect the accuracy of positioning. There may be a large number of UEs (and base stations) that can serve as anchor nodes/UEs for sidelink positioning although not all of these anchor nodes/UEs may be suitable for the desired positioning method or accuracy. However, there are no appropriate procedures in place to select appropriate anchor nodes.

Accordingly, the present disclosure seeks to provide methods and associated apparatus that address or at least alleviate (at least some of) the above-described issues.

### Solution to Problem

In one aspect, the present disclosure provides a method performed by a network node, the method comprising: receiving location information of a user equipment (UE) configured for UE-to-UE direct communication and chosen as an anchor UE; receiving assistance information indicating at least one characteristic relating to a location of the anchor UE; and using the location information and the assistance information in a procedure for determining a location of a target UE. The location information and the assistance information may be received periodically or on-demand. The at least one characteristic relating to a location of the anchor UE may be a change of the location of the anchor UE or a time stamp.

The assistance information may include at least one of: a time value associated with the location information, information identifying a velocity of the anchor UE, information identifying a heading direction of the UE, information relating to a relative velocity of the UE, and information identifying a doppler effect associated with a signal used in the procedure for determining the location of the target UE. The time value associated with the location information may indicate a time of obtaining the location information or a time of transmitting, by the anchor UE, using UE-to-UE direct communication, of a positioning reference signal or a sounding reference signal associated with the location information.

In one aspect, the present disclosure provides a method performed by a user equipment (UE) configured for UE-to-UE direct communication and chosen as an anchor UE, the method comprising: transmitting, to a network node, location information of the UE and assistance information indicating at least one characteristic relating to a location of the UE, for use by the network node in a procedure for determining a location of a target UE.

The network node may be a further UE, a base station, or a positioning function entity.

In one aspect, the present disclosure provides a method performed by a first user equipment (UE) configured for UE-to-UE direct communication, the method comprising: receiving, from a network node, information identifying a continuous resource for transmission of a positioning reference signal for a second UE; and transmitting the positioning reference signal using the continuous resource.

The transmitting the positioning reference signal may be performed across an entire configured bandwidth used for the UE-to-UE direct communication, and the information indicating the continuous resource may indicate a time period for transmitting the positioning reference signal.

The transmitting the positioning reference signal may be performed across an entire configured bandwidth used for the UE-to-UE direct communication, and the transmitting the positioning reference signal may be performed using a common part of the continuous resource and a predetermined resource pool for transmitting the positioning reference signal.

The transmitting the positioning reference signal may be performed across an entire configured bandwidth used for the UE-to-UE direct communication, and the method may comprise: selecting, from the continuous resource, at least one specific resource by performing spectrum sensing, and the transmitting the positioning reference signal may be performed using the at least one specific resource.

The continuous resource may indicates a resource pool, and the transmitting the positioning reference signal may be performed using at least one resource included in the resource pool.

The continuous resource may be represented by bitmap information.

In one aspect, the present disclosure provides a method performed by a network node, the method comprising: transmitting, to a first user equipment (UE) configured for UE-to-UE direct communication, information identifying a continuous resource in at least one of time domain and frequency domain for transmission of a positioning reference signal for a second UE.

In one aspect, the present disclosure provides a method performed by a user equipment (UE), the method comprising: receiving first configuration information for UE-to-UE direct communication, the first configuration information including information identifying, within a slot, at least one symbol for one or more of a physical sidelink control channel (PSCCH), a physical sidelink feedback channel (PSFCH), at least one automatic gain control (AGC), and at least one guard symbol; and transmitting the positioning reference signal using one or more other symbol than the at least one symbol based on the first and second configuration information.

The method may further comprise: receiving second configuration information for transmitting a positioning reference signal, wherein the second configuration information identifies an offset, in a number of symbols, for determining a starting symbol to be used for transmitting the positioning reference signal; and puncturing the positioning reference signal on the at least one symbol.

The method may further comprise: receiving second configuration information for transmitting a positioning reference signal, wherein the second configuration information identifies, based on a maximum number of symbols for the PSCCH, an offset for determining a starting symbol to be used for transmitting the positioning reference signal.

The offset may be selected from a range having: a minimum value equal to the maximum number of symbols for the PSCCH plus one; and a maximum value equal to a total number of symbols in the slot minus a count of the at least one symbol.

The method may further comprise: receiving, via sidelink control information (SCI), second configuration information for transmitting the positioning reference signal over at least one specific symbol in a slot.

The positioning reference signal may be an aperiodic positioning reference signal.

In one aspect, the present disclosure provides a method performed by a network node, the method comprising: transmitting, to a user equipment (UE), first configuration information for UE-to-UE direct communication, the configuration information including information identifying, within a slot, at least one symbol for one or more of a physical sidelink control channel (PSCCH), a physical sidelink feedback channel (PSFCH), at least one automatic gain control (AGC) symbol, and at least one guard symbol; and transmitting, to the UE, second configuration information for transmitting a positioning reference signal using one or more other symbol than the at least one symbol.

In one aspect, the present disclosure provides a method performed by a network node for positioning of a user equipment (UE) configured for UE-to-UE direct communication, the method comprising: performing a phase measurement based positioning; performing at least one other type of positioning; and determining a location of the UE based on the phase measurement based positioning and the at least one other type of positioning.

The at least one other type of positioning may include one or more of: a positioning based on a timing of a positioning reference signal; a positioning based on a power of a positioning reference signal; a positioning based on an angle-of-departure of a positioning reference signal; and a positioning based on an angle-of-arrival of a positioning reference signal.

The phase measurement based positioning and the at least one other type of positioning may use respective positioning reference signal resource sets.

The respective positioning reference signal resource sets may be mutually exclusive to each other. Alternatively, the respective positioning reference signal resource sets may be at least partially overlapping.

The method may further comprise: performing a measurement of arrival time difference for a positioning reference signal in an overlapping set; and performing a measurement of phase of the positioning reference signal in the overlapping set; and the location of the UE may be determined based on the arrival time difference and the phase of the positioning reference signal in the overlapping set.

In one aspect, the present disclosure provides a method performed by a user equipment (UE) configured for UE-to-UE direct communication, the method comprising: receiving information identifying at least one period associated with the UE for muting transmission of a positioning reference signal by the UE, wherein the period is defined on a symbol or slot level.

The information may identify the at least one period based on a pattern. The at least one period associated with the UE may be different to a further at least one period associated with a further UE. The at least one period associated with the UE may be based on a random pattern.

The at least one period associated with the UE may be applicable when transmissions by a serving or adjacent base station are muted; and the method may further comprise transmitting a positioning reference signal in the at least one period associated with the UE, in a case that transmissions by the serving or adjacent base station are muted.

The method may further comprise transmitting a positioning reference signal in the at least one period associated with the UE, regardless whether transmissions by a serving or adjacent base station are muted or not.

In one aspect, the present disclosure provides a method performed by a network node, the method comprising: transmitting, to a user equipment (UE) configured for UE-to-UE direct communication, information identifying at least one period associated with the UE for muting transmission of a positioning reference signal by the UE, wherein the period is defined on a symbol or slot level.

In one aspect, the present disclosure provides a method performed by a user equipment (UE) configured for UE-to-UE direct communication, the method comprising: performing a plurality of measurements based on respective positioning reference signals transmitted by a plurality of anchor UEs; transmitting, to a network node, results of the plurality of measurements and respective identifiers associated with the anchor UEs to which the results relate; and receiving, from the network node, at least one of the respective identifiers indicating one or more anchor UE to be used in determining a current location of the UE.

In one aspect, the present disclosure provides a method performed by a network node, the method comprising: receiving, from a user equipment (UE) configured for UE-to-UE direct communication, results of a plurality of measurements based on respective positioning reference signals transmitted by a plurality of anchor UEs and respective identifiers associated with the anchor UEs to which the results relate; and transmitting, to the UE, at least one of the respective identifiers indicating one or more anchor UE to be used in determining a current location of the UE.

The method may further comprise: selecting the one or more anchor UE to be used in determining a current location of the UE based on at least one criterion.

In one aspect, the present disclosure provides a method performed by a user equipment (UE) configured for UE-to-UE direct communication, the method comprising: receiving, from an anchor UE, at least one of information indicating whether a location of the anchor UE is available and information indicating whether the anchor UE can be used for positioning; and transmitting a request to the anchor UE for determining a current location of the UE in a case that the location of the anchor UE is available and the anchor UE can be used for positioning.

The method may further comprise: receiving, from each one of a plurality of anchor UEs, respective information indicating whether a location of the one of the plurality of anchor UEs is available; and selecting one or more of the plurality of anchor UEs, based on at least one criterion, for determining the current location of the UE.

The at least one criterion may include one or more of: a location availability criterion; a velocity criterion; a received signal power criterion; and a received signal quality criterion.

The network node may be a base station, or a UE, or a positioning function entity.

In one aspect, the present disclosure provides a network node comprising: means (for example a memory, a controller, and a transceiver) for receiving location information of a user equipment (UE) configured for UE-to-UE direct communication and chosen as an anchor UE; means for receiving assistance information indicating at least one characteristic relating to a location of the anchor UE; and means for using the location information and the assistance information in a procedure for determining a location of a target UE.

In one aspect, the present disclosure provides a user equipment (UE) configured for UE-to-UE direct communication and chosen as an anchor UE, the UE comprising: means (for example a memory, a controller, and a transceiver) for transmitting, to a network node, location information of the UE and assistance information indicating at least one characteristic relating to a location of the UE, for use by the network node in a procedure for determining a location of a target UE.

In one aspect, the present disclosure provides a first user equipment (UE) configured for UE-to-UE direct communication, the first UE comprising: means (for example a memory, a controller, and a transceiver) for receiving, from a network node, information identifying a continuous resource for transmission of a positioning reference signal for a second UE; and means for transmitting the positioning reference signal using the continuous resource.

In one aspect, the present disclosure provides a network node comprising: means (for example a memory, a controller, and a transceiver) for transmitting, to a first user equipment (UE) configured for UE-to-UE direct communication, information identifying a continuous resource in at least one of time domain and frequency domain for transmission of a positioning reference signal for a second UE.

In one aspect, the present disclosure provides a user equipment (UE) comprising: means (for example a memory, a controller, and a transceiver) for receiving first configuration information for UE-to-UE direct communication, the first configuration information including information identifying, within a slot, at least one symbol for one or more of a physical sidelink control channel (PSCCH), a physical sidelink feedback channel (PSFCH), at least one automatic gain control (AGC), and at least one guard symbol; and means for transmitting the positioning reference signal using one or more other symbol than the at least one symbol based on the first and second configuration information.

In one aspect, the present disclosure provides a network node comprising: means (for example a memory, a controller, and a transceiver) for transmitting, to a user equipment (UE), first configuration information for UE-to-UE direct communication, the configuration information including information identifying, within a slot, at least one symbol for one or more of a physical sidelink control channel (PSCCH), a physical sidelink feedback channel (PSFCH), at least one automatic gain control (AGC) symbol, and at least one guard symbol; and transmitting, to the UE, second configuration information for transmitting a positioning reference signal using one or more other symbol than the at least one symbol.

In one aspect, the present disclosure provides a network node for positioning of a user equipment (UE) configured for UE-to-UE direct communication, the network node comprising: means (for example a memory, a controller, and a transceiver) for performing a phase measurement based positioning; means for performing at least one other type of positioning; and means for determining a location of the UE based on the phase measurement based positioning and the at least one other type of positioning.

In one aspect, the present disclosure provides a user equipment (UE) configured for UE-to-UE direct communication, the UE comprising: means (for example a memory, a controller, and a transceiver) for receiving information identifying at least one period associated with the UE for muting transmission of a positioning reference signal by the UE, wherein the period is defined on a symbol or slot level.

In one aspect, the present disclosure provides a network node comprising: means (for example a memory, a controller, and a transceiver) for transmitting, to a user equipment (UE) configured for UE-to-UE direct communication, information identifying at least one period associated with the UE for muting transmission of a positioning reference signal by the UE, wherein the period is defined on a symbol or slot level.

In one aspect, the present disclosure provides a user equipment (UE) configured for UE-to-UE direct communication, the UE comprising: means (for example a memory, a controller, and a transceiver) for performing a plurality of measurements based on respective positioning reference signals transmitted by a plurality of anchor UEs; means for transmitting, to a network node, results of the plurality of measurements and respective identifiers associated with the anchor UEs to which the results relate; and means for receiving, from the network node, at least one of the respective identifiers indicating one or more anchor UE to be used in determining a current location of the UE.

In one aspect, the present disclosure provides a network node comprising: means (for example a memory, a controller, and a transceiver) for receiving, from a user equipment (UE) configured for UE-to-UE direct communication, results of a plurality of measurements based on respective positioning reference signals transmitted by a plurality of anchor UEs and respective identifiers associated with the anchor UEs to which the results relate; and means for transmitting, to the UE, at least one of the respective identifiers indicating one or more anchor UE to be used in determining a current location of the UE.

In one aspect, the present disclosure provides a user equipment (UE) configured for UE-to-UE direct communication, the UE comprising: means (for example a memory, a controller, and a transceiver) for receiving, from an anchor UE, at least one of information indicating whether a location of the anchor UE is available and information indicating whether the anchor UE can be used for positioning; and means for transmitting a request to the anchor UE for determining a current location of the UE in a case that the location of the anchor UE is available and the anchor UE can be used for positioning.

Aspects of the present disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the present disclosure will be described in detail in the context of a 3GPP system (5G networks), the principles of the present disclosure can be applied to other systems as well.

The present disclosure is defined by the claims appended hereto. Aspects of the present disclosure are as set out in the independent claims. Some optional features are set out in the dependent claims.

However, each feature disclosed in this specification (which term includes the claims) and/or shown in the drawings may be incorporated in the present disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the present disclosure will now be described, by way of example, with reference to the accompanying drawings in which:

FIG. 1 illustrates schematically a mobile (cellular or wireless) telecommunication system to which example embodiments of the present disclosure may be applied;

FIG. 2 illustrates schematically an exemplary scenario in which example embodiments of the present disclosure may be applicable;

FIG. 3 is a schematic block diagram of a mobile device forming part of the system shown in FIG. 1;

FIG. 4 is a schematic block diagram of an access network node (e.g. base station) forming part of the system shown in FIG. 1;

FIG. 5 is a schematic block diagram of a core network node forming part of the system shown in FIG. 1;

FIG. 6A illustrates schematically one exemplary way in which positioning may be realised in the system shown in FIG. 1;

FIG. 6B illustrates schematically one exemplary way in which positioning may be realised in the system shown in FIG. 1;

FIG. 7 illustrates schematically one exemplary way in which positioning may be realised in the system shown in FIG. 1;

FIG. 8 illustrates schematically one exemplary way in which positioning may be realised in the system shown in FIG. 1;

FIG. 9 illustrates schematically one exemplary way in which positioning may be realised in the system shown in FIG. 1; and

FIG. 10 illustrates schematically one exemplary way in which positioning may be realised in the system shown in FIG. 1.

### DESCRIPTION OF EMBODIMENTS

### Overview

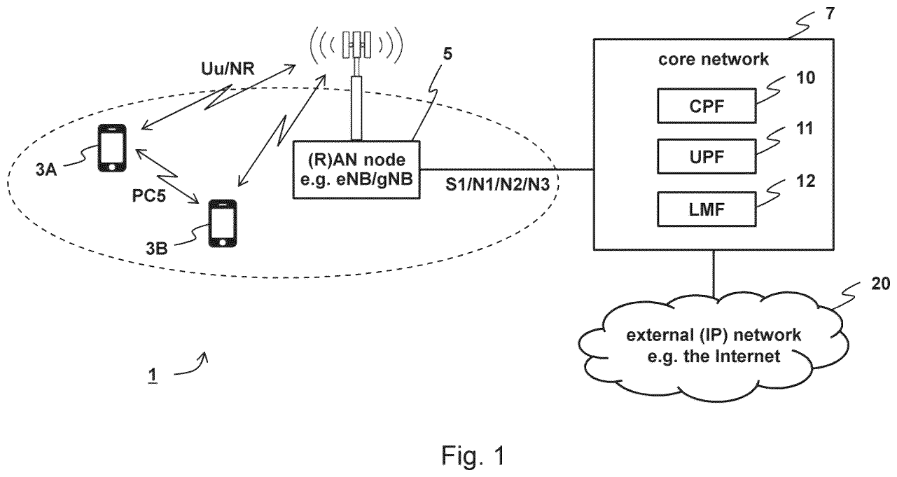

FIG. 1 illustrates schematically a mobile (cellular or wireless) telecommunication system 1 to which example embodiments of the present disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R) AN. As those skilled in the art will appreciate, whilst two mobile devices 3A and 3B and one base station 5 are shown in FIG. 1 for illustration purposes, the system, when implemented, will typically include other base stations/(R) AN nodes and mobile devices (UEs).

Each base station 5 controls one or more associated cell (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for positioning management, subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3, the Session Management Function (SMF) is responsible for handling communication sessions for the mobile devices 3 such as session establishment, modification and release, and the Location Management Function (LMF) 12 configures the UE 3 using the LTE positioning protocol (LPP) via the AMF. The core network 7 is coupled (via the UPF 11) to a data network (external (IP) network) 20, such as the Internet or a similar Internet Protocol (IP) based network.

In this system 1, direct (UE-to-UE) communication is possible between UEs 3 in each other's vicinity. For example, such direct communication may be realised based on procedures defined for the so-called Sidelink (PC5 interface) by 3GPP.

In order to realise a robust and efficient sidelink positioning, the nodes of this system are configured to support at least some of the following improvements.

In case of moving anchor nodes/UEs, the location change during the positioning procedure may affect the positioning accuracy. In this system, this issue is addressed by various types of assistance information for improving the accuracy or reliability of the positioning process. For example, a moving anchor node's location may be signalled with a time stamp (as a first type of assistance information). The time stamp may indicate the time of transmitting a positioning reference signal (e.g. PRS or SRS) associated with that location or the time when the location of the anchor node is obtained. Other type of assistance information may also be used, relating to the anchor node's location, such as velocity, heading, etc. associated with the anchor node. The velocity, heading, etc. may be given in relation to the UE 3. Using the location and the related assistance information, the UE or the network can infer the exact location of the anchor node (e.g. relative to the UE). The assistance information may also include information relating to Doppler effect of a signal. Specifically, the UE 3 may be configured to perform an appropriate measurement for Doppler (e.g. based on respective positioning reference signals) to estimate the relative velocity of the nearby anchor nodes. The UE 3 can report the measurements to the base station/LMF for network-based positioning, and obtain the exact location of the anchor node(s) from the network.

Once the location of one or more anchor node is known (including moving anchor nodes), the UE 3 is able to determine its own location based on the location of the anchor node(s).

When the UE 3 is not in the coverage of a base station it can only communicate with other UEs via the PC5 interface. This is referred to as ‘out-of-coverage’. Although the UE 3 can be configured to select resources randomly, such resources would not be periodic or continuous in frequency or time domain (due to the random selection). In order to improve positioning accuracy and reliability, the effects of such randomness may be avoided using one of the following options when transmitting a reference signal:

Option 1: the PRS is configured across entire configured bandwidth used for sidelink (for example, a bandwidth part associated with sidelink). In one alternative, the anchor node UE transmits PRS across entire configured bandwidth, but only within one of the resource pools configured for the UE (either a PRS specific resource pool or another sidelink related resource pool). Since the PRS is transmitted over the entire system bandwidth (or configured bandwidth), other channels and other PRS resources are punctured to avoid interference. In another alternative, the anchor node UE transmits PRS within a selected resource, over the entire system bandwidth or over the entire configured bandwidth, after performing sensing. In this case the selected resource may include one or more symbols and/or one or more slots. Other PRS resources are punctured.

Option 2: the anchor UE transmits PRS within a resource pool configured for the UE. However, in this case the PRS is confined within the resource pool.

Option 3: the PRS configuration is indicated explicitly. In this case, the anchor UE 3 (or base station 5, e.g. in partial coverage) explicitly indicates the resources, e.g. resource blocks (RBs), used for PRS configuration. Any UE 3 in the vicinity of the anchor UE 3 (or base station 5) can obtain the PRS configuration used by that anchor node and receive PRS using the resources indicated by the configuration.

Regarding the slot configuration for PRS, the following options may be used to avoid transmitting the PRS over unusable symbols.

Option 1: the value range of the currently defined offset is kept (i.e. dl-PRS-ResourceSymbolOffset can be set between ‘0’ and ‘12’) and the PRS is punctured on any special symbol (e.g. AGC) and/or the PSCCH. Beneficially, the PRS can be configured from the first symbol.

Option 2: a new value range is used for the offset (e.g. dl-PRS-ResourceSymbolOffset or a new sidelink specific offset) to avoid configuration of PRS on any special symbol/PSCCH. For example, the minimum value of the offset may be between 1 and NPSCCH, max+1, where NPSCCH, max is the maximum number of symbols for the PSCCH. Thus, the offset may be selected from a range between ‘1’ (or N_{PSCCH, max}+1) and ‘12’.

Option 3: the PSCCH may be avoided by configuring an aperiodic PRS via sidelink control information (SCI). In this case, the applicable PRS configuration can be provided to the UE 3 (via SCI) such that it avoids those symbols that are used for the PSCCH.

Regarding improvement of positioning accuracy when using the ITS spectrum (or other narrow bands), carrier phase based positioning method may be used for sidelink positioning. Specifically, carrier phase based positioning may be used in combination with one or more other positioning method (timing difference based positioning methods). Beneficially, the UE 3 may conduct a timing/power/AoD/AoA based positioning first, with a relatively loose accuracy requirement and then proceed to performing a carrier phase based positioning for higher accuracy with reduced complexity. The combined measurement may result in a more accurate and more resource efficient procedure than either positioning method used on its own.

When performing sidelink positioning, the UE 3 may receive PRS signals from both a base station 5 and another UE 3 acting as anchor node (anchor UE). In this case, the power of received PRS from the anchor UE 3 may be much lower than the PRS from an serving or adjacent base station. In order to address this issue, the anchor UEs 3 may be configured with respective periodic micro muting patterns or they may employ a random pattern by using a bitmap.

Regarding selection of a suitable anchor node/anchor UE, the UE 3 or the network (e.g. base station or LMF 12) may be configured to apply one or more criterion. For absolute positioning, only UEs 3 with known location should be used as anchor nodes. Even with known location, some UEs should not be used as anchor nodes, for example UEs with high velocity (due to Doppler effect). The criteria for anchor node/UE selection may include, for example: location availability for a given anchor node, velocity of a given anchor node (e.g. via Doppler measurement), received signal power and/or quality for a given anchor node (e.g. RSRP/RSRQ for sidelink), security requirement for a given anchor node (e.g. whether or not its location can be shared with other network nodes).

### User Equipment (UE)

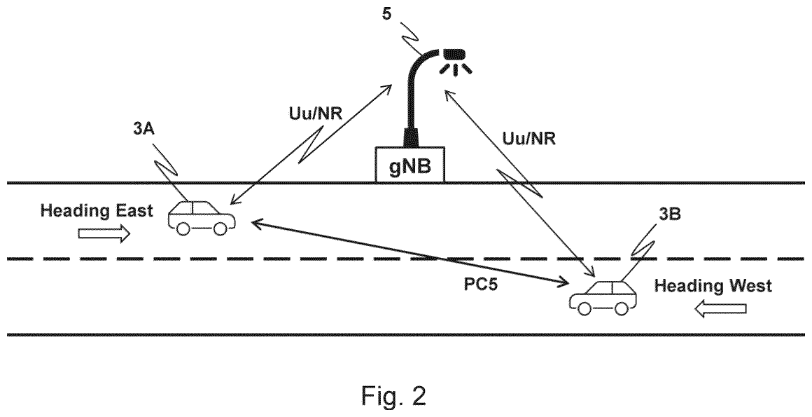

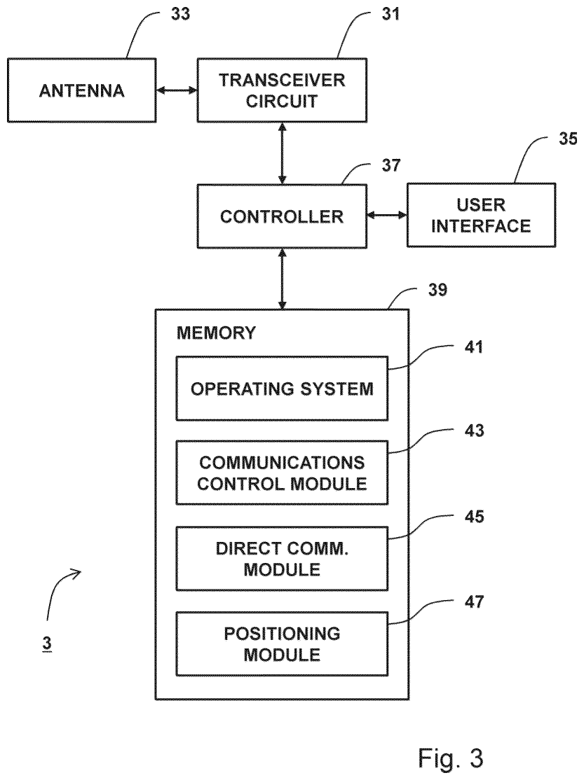

FIG. 3 is a block diagram illustrating the main components of the mobile device (UE) 3 shown in FIGS. 1 and 2. As shown, the UE 3 includes a transceiver circuit 31 which is operable to transmit signals to and to receive signals from the connected node(s) via one or more antenna 33. Although not necessarily shown in FIG. 3, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, a direct communications module 45, and a positioning module 47.

The communications control module 43 is responsible for handling (generating/sending/receiving) signalling messages and uplink/downlink data packets between the UE 3 and other nodes, including (R) AN nodes 5 and core network nodes. The signalling may comprise control signalling (e.g. via system information or RRC) related to UE positioning. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The direct communications module 45 is responsible for direct UE-to-UE communications (based on control information/configuration information obtained via the communications control module 43).

The positioning module 47 is responsible for positioning procedures including processing positioning reference signals such as PRS and SRS, and obtaining and applying PRS configuration and slot formats for sidelink positioning. The positioning module 47 may communicate (via the direct communications module 45) with other UEs 3 over an appropriate UE-to-UE interface such as Sidelink/PC5. The positioning module 47 may also communicate (via the communications control module 43) with the base station 5 and/or a positioning function entity in the core network 7 such as the LMF 12. In case of network-based positioning, the positioning function entity may assist the UE 3 in determining the UE's location (or the location of another node), or provide the location to the UE 3 (if determined by the positioning function entity itself).

### Access Network Node (Base Station)

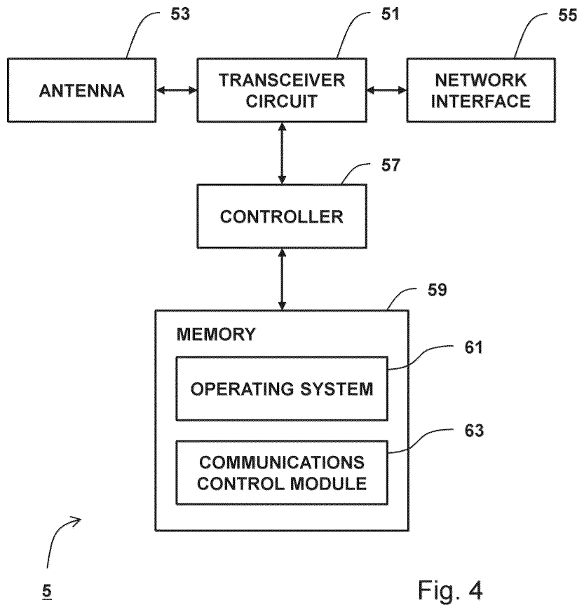

FIG. 4 is a block diagram illustrating the main components of the base station 5 (or a similar access network node) shown in FIGS. 1 and 2. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63.

The communications control module 63 is responsible for handling (generating/sending/receiving) signalling between the base station 5 and other nodes, such as the UE 3 and the core network nodes. The signalling may comprise control signalling (e.g. via system information or RRC) related to UE positioning. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

### Access Network Node (RSU)

The so-called Road Side Unit (RSU) is defined as a stationary infrastructure entity supporting V2X applications that can exchange messages with other entities supporting V2X applications. RSU is a term frequently used in existing ITS specifications, and the term has been introduced in the relevant 3GPP specifications is to make the documents easier to read for the ITS industry. RSU is a logical entity that supports V2X application logic using the functionality provided by either a 3GPP network or a UE (referred to as UE-type RSU). It should be noted that when UE or base station is mentioned in the following sections, it also refers to UE-type RSU and base station-type RSU.

### Core Network Function

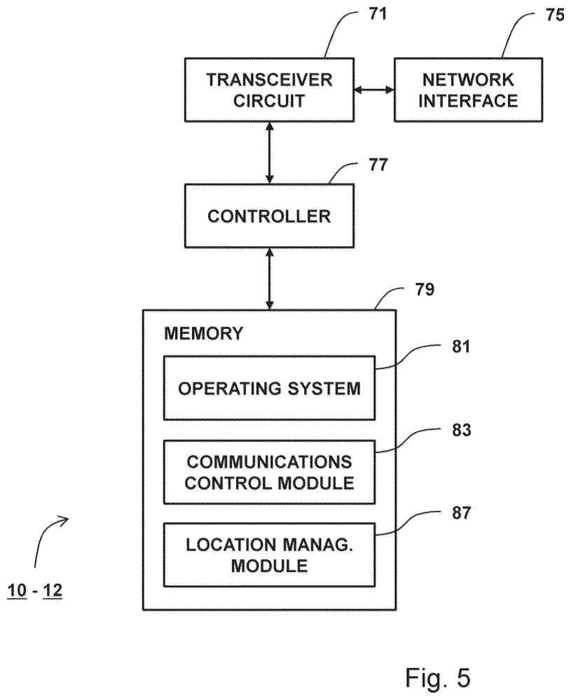

FIG. 5 is a block diagram illustrating the main components of a generic core network function, such as the CPF 10, the UPF 11, or the LMF 12 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and a location management module 87 (e.g. in case of the LMF 12).

The communications control module 83 is responsible for handling (generating/sending/receiving) signalling between the core network function and other nodes, such as the UE 3, the base station 5, and other core network nodes. The signalling may include for example signalling relating to UE positioning.

If present, the location management module 87 is responsible for (network-based) positioning procedures including providing PRS configuration and slot formats to the UE 3 for sidelink positioning. The location management module 87 communicates with the UE 3 (via the communications control module 83 and the base station 5). In case of network-based positioning, the location management module 87 assists the UE 3 in determining the UE's location (or the location of another node), or provide the location to the UE 3 (if determined by the positioning function entity itself).

### DETAILED DESCRIPTION

The 3GPP standards define downlink (DL) physical channels corresponding to resource elements (REs) carrying information originated from a higher layer, and DL physical signals which are used in the physical layer and correspond to REs which do not carry information originated from a higher layer. For example, physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as DL physical channels, and reference signals (RSs) and synchronization signals (SSs) are defined as DL physical signals. A reference signal, also called a pilot signal, is a signal with a predefined special waveform known to both the UE 3 and the base station 5. For example, cell specific reference signal, UE-specific reference signal (UE-RS), positioning reference signal (PRS), and channel state information reference signal (CSI-RS) are defined as DL reference signals. Similarly, the 3GPP standards define uplink (UL) physical channels corresponding to REs carrying information originated from a higher layer, and UL physical signals which are used in the physical layer and correspond to REs which do not carry information originated from a higher layer. For example, physical uplink shared channel (PUSCH), physical uplink control channel (PUCCH), and physical random access channel (PRACH) are defined as UL physical channels, and a demodulation reference signal (DMRS) for a UL control/data signal, and a sounding reference signal (SRS) used for UL channel measurement are defined as UL physical signals.

For sidelink, the following channels have been specified by 3GPP: physical sidelink broadcast channel (PSBCH); physical sidelink control channel (PSCCH); physical sidelink shared channel (PSSCH), physical sidelink feedback channel (PSFCH), and the physical sidelink discovery channel (PSDCH). Two sidelink specific system information blocks (SIBs) have been specified for carrying sidelink related control information (via RRC): SIB18 and SIB19.

Positioning may refer to determining the geographical position and/or velocity of the UE 3 based on measurement of radio signals. Location information may be requested by and reported to a client (e.g. an application) associated with the UE 3. The location information may also be requested by a client within or connected to the core network 7. The location information may be reported in standard formats such as formats for cell-based or geographical coordinates, together with estimated errors of the position and velocity of the UE 3 and/or a positioning method used for positioning.

Positioning methods supported in the NG-RAN may include, amongst others: RAT-dependent methods including Observed Time Difference Of Arrival (OTDOA) based positioning; Uplink Time Difference of Arrival (UTDOA) based positioning; Roundtrip time (RTT) based positioning; and RAT-independent methods including Global Navigation Satellite System (GNSS) based positioning; barometric sensor based positioning; and Bluetooth based positioning.

For some of these positioning methods, a positioning reference signal (PRS) may be used. The PRS is a reference signal used to estimate the position of the UE 3.

For example, the OTDOA positioning method uses time difference of DL signals received by the UE 3 from multiple anchor nodes. The UE 3 measures time of received DL signals using location assistance data received from a location server, or in case of sidelink positioning, from a nearby UE 3 or base station 5. The position of the UE 3 may be determined based on the measurement result and known geographical coordinates of the neighboring anchor nodes. The anchor nodes may include base stations 5 and other UEs 3 with known location. Similarly, the UTDOA positioning method uses the arrival time difference of sounding reference signals (SRSs) at multiple anchor nodes (UEs 3 and/or base stations 5). In the following description, the term positioning reference signal will be used to refer to any one of PRS, SRS, and S-PRS (and any other signal suitable for determining the position of a UE) unless otherwise stated.

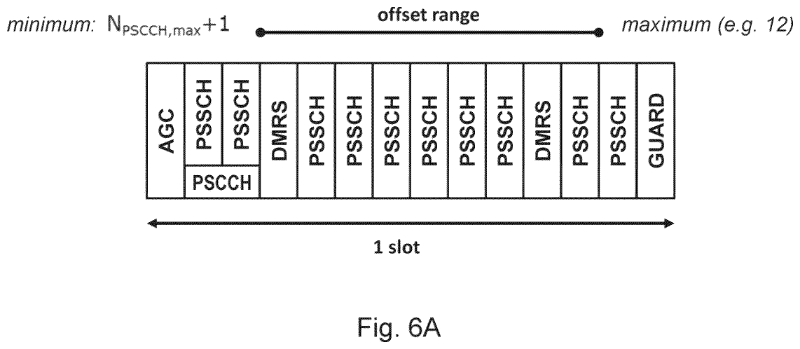

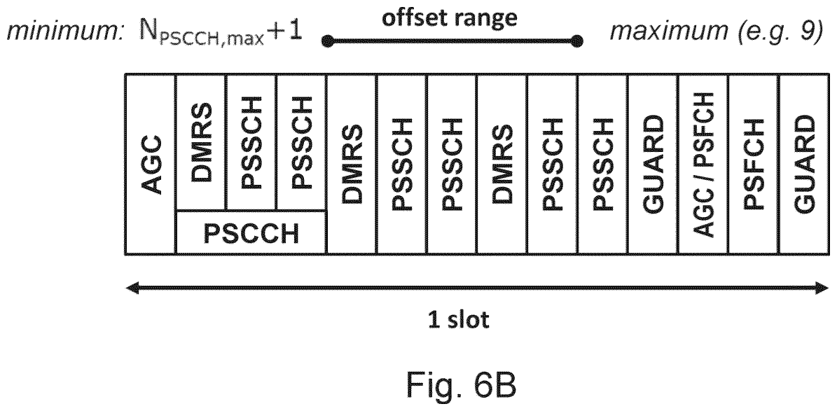

The following is a description of how sidelink positioning may be realised in the system 1 shown in FIG. 1, with reference to FIGS. 6A to 10.

### Moving Anchor Nodes

The current (Release 16/17) 3GPP positioning methods, especially DL positioning methods such as OTDOA, RTT, AOA/D, etc assume fixed (stationary) anchor nodes with known location, such as base stations.

In sidelink positioning, V2X is one of the most important use cases. In V2X, when using another UE 3 (vehicle or road user) with known location as an anchor node, it is quite likely that this UE 3 is moving. According to 3GPP TR 38.845 V17.0.0 (NPL 7), UE velocities up to 250 km/h needs to be supported for outdoor and tunnel areas so that the relative velocity can be up to 500 km/h between two moving vehicles. In case of trains, velocities up to 500 km/h may be supported, giving a maximum relative velocity of 1000 km/h between two moving trains (or UEs on such trains).

FIG. 2 illustrates a scenario with two UEs 3A and 3B (cars) travelling in the opposite direction. The UEs 3A and 3B may be in the vicinity of a base station 5 and communicate with the base station 5 using the Uu/NR air interface. The UEs 3A and 3B may also communicate with each other directly, via ‘sidelink’, using the PC5 interface.

If the location of vehicle A is assumed to be known, it can be used as an anchor node in addition to the base station 5 (gNB) along the road for positioning of vehicle B. However, unlike the fixed base station 5 along the road, vehicle A is moving. For example, assuming the relative velocity is 500 km/h and the maximum allowed positioning latency is 100 ms, the distance between the original location of the moving anchor nodes, i.e. vehicle A at the beginning of the positioning procedure and the location at the end of the procedure can be more than 13 meters.

Thus, the location change of moving anchor nodes during the positioning procedure will affect the positioning accuracy, especially for use cases/scenarios that require sub-meter accuracy.

In this system, the above issue can be addressed using one of the following options, which rely on various type of assistance information for improving the accuracy or reliability of the positioning process:

Option 1: signalling of moving anchor node's location with a time stamp. In the case of network-based positioning, each (moving) anchor node, e.g. UE/vehicle 3A, reports its own location to the network with a time stamp indicating the time of transmitting a positioning reference signal (e.g. PRS or SRS) associated with that location or the time when the location of the anchor node is obtained. Similarly, in the case of UE-based positioning, each (moving) anchor node, e.g. UE/vehicle 3A, reports its own location to another UE/vehicle 3B with a time stamp indicating the time of transmitting a positioning reference signal associated with that location or the time when the location of the anchor node is obtained. Both periodic and on-demand location reporting may be used in this option.

Option 2: signalling of moving anchor node's location related information. In the case of network-based positioning, each (moving) anchor node, e.g. UE/vehicle 3A, reports its own location to the network with additional assistance information such as velocity, heading, etc. associated with that anchor node. The velocity, heading, etc. may be given in relation to the UE 3. Using the location and the related assistance information, the network is able to infer the exact location of the anchor node. Similarly, in the case of UE-based positioning, each (moving) anchor node, e.g. vehicle 3A, reports its own location to vehicle 3B with additional assistance information such as velocity, heading, etc. associated with that anchor node (e.g. relative to the UE). The other UE/vehicle 3B is able to infer the exact location of the anchor node based on the reported location and the related assistance information. Both periodic and on-demand location reporting may be used in this option.

Option 3: assistance information including a measurement of Doppler. In this case, the UE 3 may be configured to perform an appropriate measurement for Doppler (e.g. based on respective positioning reference signals) to estimate the relative velocity of the anchor nodes. The UE 3 can report the measurements to the base station for network-based positioning, and obtain the exact location of the anchor node from the network.

Once the location of one or more anchor node is known (including moving anchor nodes), the UE 3 is able to determine its own location based on the location of the anchor node(s). It will be appreciated that different options may be applied to different anchor nodes. If the anchor node is a UE 3, it may also be referred to as an anchor UE 3.

If network-based positioning is used, the UE 3 may be communicating with a positioning function entity in the core network 7, e.g. a location management function (LMF). The positioning function entity may assist the UE 3 in determining its location (or the location of another node). Alternatively, the positioning function entity may determine the location of the UE 3 (or another node) and provide the location to the UE 3.

### PRS Resource Allocation for Out-of-Coverage UEs

When a UE 3 communicates via sidelink, PSCCH/PSSCH cannot be transmitted anywhere in the NR system bandwidth, nor within the frequency span configured for sidelink. Instead, resource pools are defined for the respective channels.

The term ‘out-of-coverage’ refers to the scenario where the UE 3 is not in the coverage of a base station and can only communicate with other UEs via the PC5 interface. In this case, the current standards state that the UE 3 need to apply autonomous resource allocation, which is determined through a sensing procedure conducted autonomously before transmitting by the UE 3. However, since the UE 3 selects the appropriate amount of resources randomly, the selected resources are not generally periodic and they can be non-continuous in either frequency or in time domain (due to the random selection). If such autonomous resource allocation would be applied to positioning reference signals, it may be difficult to ensure positioning accuracy and reliability due to the randomness of the signals.

This issue can be addressed using one of the following options for transmitting a reference signal:

Option 1: PRS is configured across entire configured bandwidth used for sidelink (for example, a bandwidth part associated with sidelink). In this case, the anchor node UE 3 transmits PRS across the entire system bandwidth (or configured bandwidth, e.g. bandwidth part) no matter whether the resources are in or out of any resource pool for PSCCH/PSSCH or other channels. This alternative may be combined with certain predefined restrictions, such as transmitting PRS at specific times and/or periodically (in which case the activation time(s) or periodicity may be configured by the network).

In a first modification of this option, the anchor node UE transmits PRS across entire configured bandwidth, but only within one of the resource pools configured for the UE. The resource pools may include a transmit resource pool, a receive resource pool, an overlapping part of transmit and receive resource pools, and a collection of transmit and receive resource pools. The resource pools may be the resource pools for PSCCH/PSSCH or a dedicated resource pool for PRS. Since PRS is transmitted over the entire system bandwidth or configured bandwidth, other channels and other PRS resources are punctured to avoid interference.

In another modification of this option, the anchor node UE transmits PRS within a selected resource, over the entire system bandwidth or over the entire configured bandwidth, after performing sensing. In this case the selected resource may include one or more symbols and/or one or more slots. Other PRS resources are punctured.

Option 2: Similarly to the first modification of Option 1, the anchor UE transmits PRS within a resource pool configured for the UE. However, in this case the PRS is confined within the resource pool. The resource pool may be a dedicated resource pool for PRS or one of the resource pools configured for PSCCH/PSSCH. The resource used for PRS transmission may be chosen from a transmit resource pool, a receive resource pool, an overlapping part of transmit and receive resource pools, or a collection of transmit and receive resource pools.

Option 3: Explicit indication of PRS configuration—in this case, the anchor UE 3 (or base station 5, e.g. in partial coverage) explicitly indicates the resources, e.g. resource blocks (RBs), used for PRS configuration. For example, the resources may be indicated using a bitmap (1D or 2D bitmap) and/or the like. In this case, any UE 3 in the vicinity of the anchor UE 3 (or base station 5) can obtain the PRS configuration used by that anchor node and receive PRS using the resources indicated by the configuration.

Although Options 1 to 3 are particularly beneficial for out-of-coverage UEs 3, it will be appreciated that the same approach may be applicable to in-coverage or partial coverage UEs 3.

When puncturing is used, the UE 3 may be configured to employ one of the following puncturing modes.

Puncturing mode 1: PRS sequence is not continuous—in this case PRS may be configured contiguously over a plurality of resources but the PRS sequence is punctured in the resources used by other UEs or channels (i.e. the PRS sequence is not continuous). For example, a twelve-bit PRS sequence {1 0 1 0 1 1 1 1 0 1 0 1} may be punctured at the middle four bits ({1 1 1 1}) resulting in punctured sequence {1 0 1 0 0 1 0 1}.

Puncturing mode 2: PRS sequence is continuous—in this case PRS is configured for only those resources that are not used by other UEs or channels. For example, for the same sequence {1 0 1 0 1 1 1 1 0 1 0 1}, the resulting PRS will be {1 0 1 0 1 1 1 1} when four bits are used for other purposes.

It will be appreciated that the network may indicate to the UE 3 which puncturing mode to use (e.g. via system information or sidelink control information).

### Slot Format for PRS

FIGS. 6A and 6B illustrate two exemplary sidelink slot formats with different PSCCH and PSSCH configurations. The slot format of sidelink is different to that of the interface between the base station 5 and the UE 3 (e.g. the Uu interface). For example, for PSSCH transmission, there can be from 7 to 14 of the symbols within the slots reserved for sidelink operation, of which PSSCH can be transmitted in 5 to 12 symbols. The remaining sidelink symbols transmit some or all of the PSCCH and PSFCH, at least one automatic gain control (AGC) symbol, and at least one guard symbol.

In the current standards, PRS can be configured with an offset having values between ‘0’ and ‘12’ (dl-PRS-ResourceSymbolOffset). The configuration of PRS does not need to take PDCCH into consideration since it can be assumed that no traffic is transmitted during the positioning procedure. However, some symbols, e.g., AGC symbol is not suitable for PRS. Moreover, the PSCCH and PSSCH are multiplexed in frequency domain. Thus, the current approach based on dl-PRS-ResourceSymbolOffset does not match the sidelink slot formats because it may result in configuring unusable symbols.

This issue can be addressed using one of the following options:

Option 1: the value range of the offset is kept (i.e. dl-PRS-ResourceSymbolOffset can be set between ‘0’ and ‘12’) and PRS is punctured on any special symbol (e.g. AGC) and/or the PSCCH. Thus, the PRS can be configured from the first symbol.

Option 2: a new value range is used for the offset (e.g. dl-PRS-ResourceSymbolOffset or a new sidelink specific offset) to avoid configuration of PRS on any special symbol/PSCCH. For example, the minimum value of the offset may be between 1 and NPSCCH, max+1, where NPSCCH, max is the maximum number of symbols for the PSCCH. Thus, the offset may be selected from a range between ‘1’ (or N_{PSCCH, max}+1) and ‘12’.

Alternatively, PSCCH may be avoided using a different approach. In sidelink positioning, due to the dynamic resource allocation, PRS over the PC5 interface may need to be more dynamic than PRS over the Uu interface, thus an aperiodic PRS may be configured by appropriately formatted sidelink control information (SCI). In this case, the applicable PRS configuration can be provided to the UE 3 (via SCI) such that it avoids those symbols that are used for the PSCCH.

### Carrier Phase Based Positioning

The spectrum used for sidelink positioning includes ITS and licensed bands. The available ITS bandwidth is less than 80 MHz and in some countries only 20 MHz is allocated to ITS. Since positioning accuracy is related to the PRS bandwidth (the larger the bandwidth, the more accurate positioning can be achieved), the ITS spectrum may not be able to provide sufficient accuracy when timing difference based positioning methods are used.

In order to address this issue, carrier phase based positioning method may be used for sidelink positioning. Specifically, carrier phase based positioning may be used in combination with one or more other positioning method (timing difference based positioning methods). Carrier phase measurements require a relatively small bandwidth and they are roughly 1000 times less noisy and much less sensitive to multipath than code phase measurements. However, the complexity to solve integer ambiguity for carrier phase measurements is quite high, especially for the power saving users or low complexity UEs.

Beneficially, the combination of phase based positioning and one or more of other positioning methods may be used to address these issues.

The other positioning methods may include:
a positioning method based on a timing of a positioning reference signal;
a positioning method based on a power of a positioning reference signal;
a positioning method based on an angle-of-departure (AoD) of a positioning reference signal; and
a positioning method based on an angle-of-arrival (AoA) of a positioning reference signal.

The positioning reference signal used in the above positioning methods (including the carrier phase based positioning method) may be PRS or SRS, or any other suitable reference signal.

In order to realise such combined positioning, multiple positioning reference signal resource sets may be configured for the phase based positioning and the timing/power/AoD/AoA based positioning, respectively. These reference signal resource sets can be mutually exclusive to each other or they might be overlapping (at least partially).

For a timing based positioning reference signal set, the UE 3 measures an arrival time difference. For the phase based positioning reference signal set, the UE 3 measures measure phase of the reference signal. For positioning reference signals in both sets, the UE 3 performs joint measurement for both arrival time difference and phase.

Beneficially, the UE 3 may conduct timing/power/AoD/AoA based positioning first, with a relatively loose accuracy requirement to reduce the searching space to solve integer ambiguity. The UE 3 may then proceed to carrier phase based positioning for higher accuracy with reduced complexity.

In order to apply such combined positioning, UE capability may be defined from measurement or positioning method perspectives, respectively. From measurement perspective, the UE 3 can indicate to the anchor node if it is capable to measure phase. From positioning method perspective, the UE 3 can indicate to the anchor node if it is capable of conducting carrier phase-based positioning.

### PRS Muting

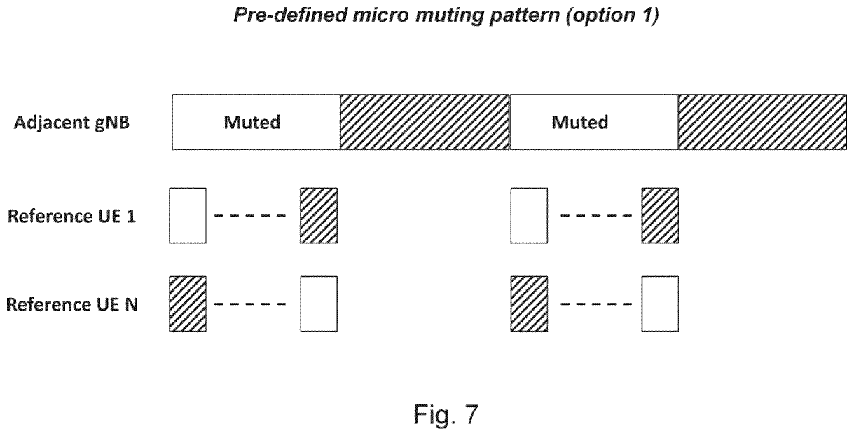

FIGS. 7 to 10 illustrate schematically some exemplary ways in which muting of PRS transmissions may be realised in the system shown in FIGS. 1 and 2.

In NR, PRS muting is used to reduce the interference of serving or adjacent base stations when the UE 3 receives PRS from a base station 5 located relatively far away. 3GPP TS 38.211 V17.0.0 (NPL 8) defines two ways for muting PRS resources:
Mute the PRS resource set instances using the properties MutingPattern1 and MutingBitRepetition of the nrPRSConfig object; and
Mute the PRS resource repetition indices using the property MutingPattern2 of the nrPRSConfig object.

However, for sidelink positioning, the UE 3 may receive PRS signals from both a base station 5 and another UE 3 acting as anchor node (anchor UE). In this case, the power of received PRS from the anchor UE 3 may be much lower than the PRS from an serving or adjacent base station.

In order to address this issue, the anchor UEs 3 may be configured with respective periodic micro muting patterns or they may employ a random pattern by using a bitmap.

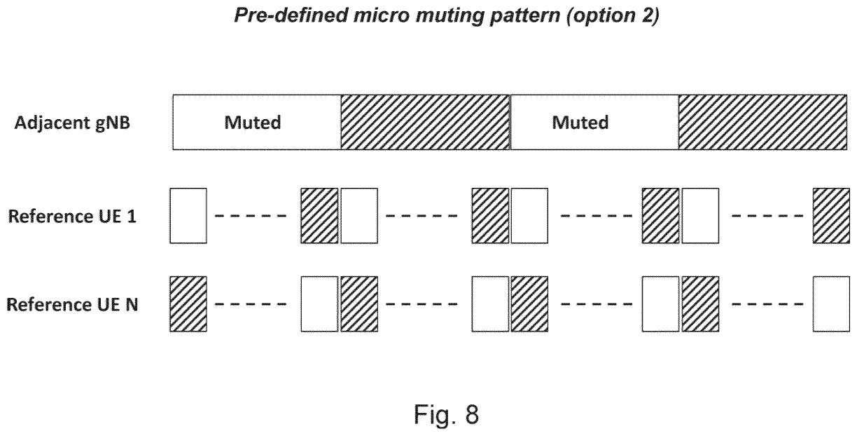

In more detail, a pre-defined periodic micro muting may be applied by the anchor UEs 3 as follows:
A pre-defined micro muting pattern with a relatively fine time granularity (e.g. slot or symbol level granularity, shorter or equal to the muting periodicity of base station) may be configured for each anchor UE 3 to be applied during the muting periods of adjacent base station(s) 5. In other words, each anchor UE 3 is only allowed to transmit when the serving or adjacent base station(s) 5 is (are) muted, as shown in FIG. 7. In this case, different UEs 3 may be configured with different muting patterns.
A pre-defined micro muting pattern with a relatively fine time granularity (e.g. slot or symbol level granularity, shorter or equal to the muting periodicity of base station) may be configured for each anchor UE 3 and the UEs 3 may apply their respective pattern regardless whether the serving or adjacent base station 5 is muted or not. In other words, it may not be necessary for the UEs 3 to determine the muting pattern of the serving or adjacent base station(s) 5 (although they may employ sensing before transmitting PRS). An example of this approach is shown in FIG. 8, for two UEs 3.

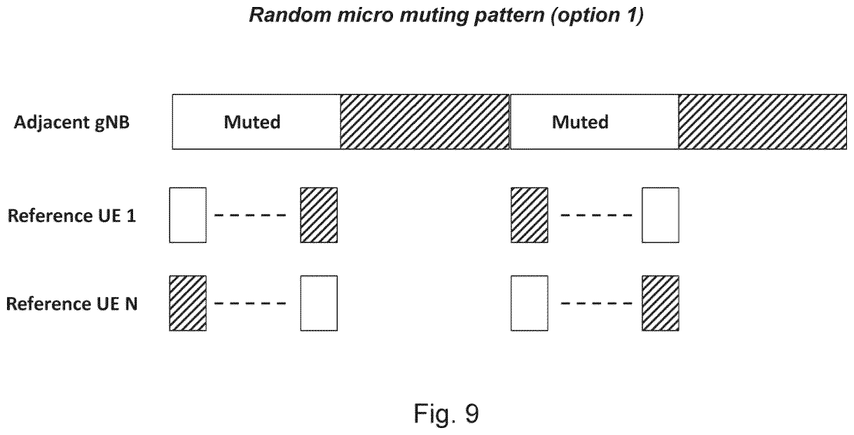

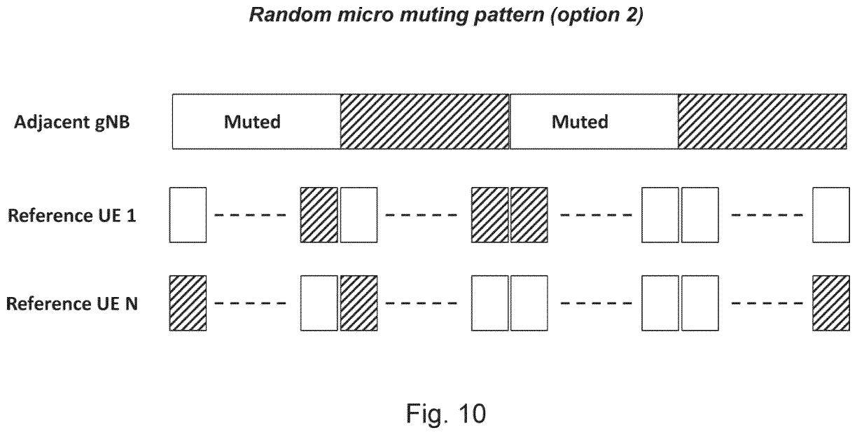

Alternatively, a random micro muting may be applied by the anchor UEs 3:
A random micro muting pattern with a relatively fine time granularity (e.g. slot or symbol level granularity, shorter or equal to the muting periodicity of base station) may be configured for each anchor UE 3 to be applied during the muting periods of adjacent base station(s) 5. In this case, as shown in FIG. 9, each anchor UE 3 is only allowed to transmit when the serving or adjacent base station(s) 5 is (are) muted.
A random micro muting pattern with a relatively fine time granularity (e.g. slot or symbol level granularity, shorter or equal to the muting periodicity of base station) may be configured for each anchor UE 3 and the UEs 3 may apply their respective pattern regardless whether the serving or adjacent base station 5 is muted or not. An example of this approach is shown in FIG. 10.

The random muting pattern may be pre-defined (e.g. derived based on a UE specific parameter) or may be signalled to the anchor UEs 3 by the network (e.g. the LMF 12 via the base station 5).

### Anchor UE Selection

In Release-17, PRS can be configured for a serving base station 5 and surrounding base stations 5. The location of each base station 5 is fixed and it is known. Accordingly, any base station 5 can be used as an anchor node for positioning. In the case of sidelink positioning, UEs 3 (mobile devices) may also be used as anchor nodes. Thus, there may be a large number of UEs 3 (and base stations 5) that can serve as anchor nodes for sidelink positioning. However, not all of these anchor nodes may be suitable for the desired positioning method or accuracy.

The following is a description of some exemplary ways in which appropriate anchor nodes may be selected for positioning.

For absolute positioning, only UEs 3 with known location should be used as anchor nodes. Even with known location, some UEs should not be used as anchor nodes, for example UEs with high velocity (due to Doppler effect).

Beneficially, the base station 5 may be configured to coordinate (for in-coverage and partial-coverage UEs) the selection of appropriate anchor nodes for positioning. The base station 5 may use at least one criterion for anchor UE selection. Such criteria include, although not limited to, one or more of the following: location availability for a given anchor node (mandatory for absolute positioning), velocity of a given anchor node (via Doppler measurement), received signal power and/or quality for a given anchor node (e.g. RSRP/RSRQ for sidelink), security requirement for a given anchor node (e.g., whether or not its location can be shared with other network nodes).

In this case, the UE 3 reports a measurement to the network and the network selects an appropriate anchor UE based on the applicable criterion and notifies the UE 3 about the selected anchor UE(s). The UE 3 can also report to the network if it can be chosen as anchor node as UE capability.

Alternatively, selection of appropriate anchor nodes for positioning may be realised without base station coordination (e.g. for out-of-coverage case). For absolute positioning, each UE 3 may be configured to indicate if its own location is available and if it can be chosen as anchor node in unicast, group cast or broadcasting information so that nearby UEs know if that UE can be used as an anchor node. A UE 3 can send a positioning request to the UE(s) chosen as anchor node(s) based on certain criterion and the anchor UE(s) can send a response to confirm. Effectively, in this case, the requesting UE 3 may be configured to apply one or more of the criteria described above.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

The term positioning reference signal is used in the present disclosure to refer to a reference signal transmitted by a network node and used to locate the position of the network node or another network node. The network node may be a base station (gNB) for Uu interface positioning or a UE for Uu interface positioning or sidelink positioning′. PRS and SRS are used as examples of such positioning reference signals. However, any other suitable signal may be used. In the case of sidelink (PC5), the positioning reference signals may also be referred to as sidelink PRS (S-PRS) and sidelink SRS (S-SRS).

The term UE-to-UE direct communication is used in the present disclosure to refer to a scenario when two or more devices are connected and communicate directly with each other. An example of such direct communication is sidelink in 5G NR systems, although other systems may use different terminology for the same purpose.

The different types of positioning information may include:
3D coordinates (e.g. latitude and longitude, potentially also elevation, or cartesian x,y,z); and/or
distance and/or angle to an anchor node.

However, it will be appreciated that that in some use cases it might be sufficient for a vehicle (UE) to be provided only the relative distance and angle to other vehicles/UEs/traffic participants.

It will be appreciated that the above described ‘sidelink positioning’ techniques may be applicable to any of the services and use cases in Groups 1) to 3) below.

### Group 1) Lax Positioning Requirement:

Traffic Jam Warning-Urban Scenario on Road Warning
Traffic Jam Warning-Rural Scenario on Road Warning
Traffic Jam Warning-Highway Scenario on Road Warning
Rural Scenario on Route Information
Highway Scenario on Route Information
Software Update-Conventional-Routine/Urgent, Autonomous-Routine
Software Update-Autonomous-Urgent
Software Update-Without Infrastructure, Vehicle to Workshop
Remote Automated Driving Cancellation
HD Content Delivery-High-End Service for cars
HD Content Delivery-Low-End Service for cars
HD Content Delivery-Bus Passenger Service
Software Update of Reconfigurable Radio System
Patient Transport Monitoring
Automated Valet Parking (Wake Up)

### Group 2) Lane Level Positioning Requirement:

Cross-Traffic Left-Turn Assist
Intersection Movement Assist
Emergency Break Warning
Lane Change Warning—lagging vehicle, leading vehicle (highway)
Lane Change Warning—lagging vehicle, leading vehicle (urban)
Lane Change Warning—not permitted case (rural)
Vehicle Health Monitoring
Speed Harmonization
See-Through for Pass Maneuver
Obstructed View Assist via CCTV
Obstructed View Assist via Remote Vehicles
Continuous Traffic Flow via Green Lights Coordination
Vehicle collects hazard and road event for AV
Vehicles Platooning in Steady State
Cooperative Lane Merge
Autonomous Vehicle Disengagement Report
Accident Report
Awareness Confirmation
Coordinated, Cooperative Driving Manoeuvre-Cooperative Lane Change
Coordinated, Cooperative Driving Manoeuvre-Road Blockage
Bus Lane Sharing Request
Bus Lane Sharing Revocation
Vehicle Decision Assist-RV Waiting for a Short Period of Time, RV Broken Down, Bus Having to Wait
Vehicle Decision Assist-Slow Vehicle en Route

### Group 3) Below Meter Positioning Requirement:

High Definition Sensor Sharing
Vulnerable Road User-Awareness near potentially dangerous situations (urban)
Vulnerable Road User-Collision risk warning
Real-Time Situational Awareness and High-Definition Maps
Group Start
Tele-Operated Driving (TOD)
TOD support
TOD for Automated Parking
Cooperative Manoeuvres of Autonomous Vehicles for Emergency Situations
High definition map collecting and sharing
Automated Intersection crossing
Infrastructure Assisted Environment Perception-Data Distribution about Objects on the Road
Infrastructure Assisted Environment Perception-Individual Data Transmission in Form of Trajectories or Actuation Commands
Infrastructure based Tele-Operated Driving
Automated Valet Parking-Joint Authentication and Proof of Localisation
Coordinated, Cooperative Driving Manoeuvre-Pedestrian Crossing
Cooperative Traffic gap
Cooperative Lateral Parking
Cooperative Curbside Management

It will be appreciated that the above example embodiments may be applied to both 5G New Radio and LTE systems (E-UTRAN). The above example embodiments may also be applied to future systems (beyond 5G, 6G, etc.).

The next-generation mobile networks support diversified service requirements, which have been classified into three categories by the International

Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency). It will be appreciated that the positioning methods described in this document may be applicable to at least one of the above categories of UEs and/or at least one type of services.

In the above description, the UE, the access network node (base station), and the core network node are described for ease of understanding as having a number of discrete modules (such as the communication control modules). Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

The software module or the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C(F1 control plane) interface connected with the gNB-DU. gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 4) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above example embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0 (NPL 9), Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

This application is based upon and claims the benefit of priority from United Kingdom patent application No. 2206699.7, filed on May 6, 2022, the disclosure of which is incorporated herein in its entirety by reference.

The whole or part of the example embodiments disclosed above can be described as, but not limited to, the following supplementary notes.

### (Supplementary Note 1)

A method performed by a network node, the method comprising:
receiving, periodically or on-demand, location information of a user equipment (UE) configured for UE-to-UE direct communication and chosen as an anchor UE;
receiving, periodically or on-demand, assistance information indicating at least one characteristic relating to a change of a location of the anchor UE; and
using the location information and the assistance information in a procedure for determining a location of a target UE.

### (Supplementary Note 2)

The method according to Supplementary note 1, wherein the assistance information includes at least one of:
a time value associated with the location information,
information identifying a velocity of the anchor UE,
information identifying a heading direction of the UE,
information relating to a relative velocity of the UE, and
information identifying a doppler effect associated with a signal used in the procedure for determining the location of the target UE.

### (Supplementary Note 3)

The method according to Supplementary note 2, wherein the time value associated with the location information indicates a time of obtaining the location information or a time of transmitting, by the anchor UE, using UE-to-UE direct communication, of a positioning reference signal or a sounding reference signal associated with the location information.

### (Supplementary Note 4)

A method performed by a user equipment (UE) configured for UE-to-UE direct communication and chosen as an anchor UE, the method comprising:
transmitting, to a network node, location information of the UE and assistance information indicating at least one characteristic relating to a change in a location of the UE, for use by the network node in a procedure for determining a location of a target UE.

### (Supplementary Note 5)

The method according to any of Supplementary notes 1 to 4, wherein the network node is a further UE, a base station, or a positioning function entity.

### (Supplementary Note 6)

A method performed by a first user equipment (UE) configured for UE-to-UE direct communication, the method comprising:
receiving, from a network node, information identifying a continuous resource for transmission of a positioning reference signal for a second UE; and
transmitting the positioning reference signal using the continuous resource.

### (Supplementary Note 7)

The method according to Supplementary note 6, wherein
the transmitting the positioning reference signal is performed across an entire configured bandwidth used for the UE-to-UE direct communication, and
the information indicating the continuous resource indicates a time period for transmitting the positioning reference signal.

### (Supplementary Note 8)

The method according to Supplementary note 6, wherein
the transmitting the positioning reference signal is performed across an entire configured bandwidth used for the UE-to-UE direct communication, and
the transmitting the positioning reference signal is performed using a common part of the continuous resource and a predetermined resource pool for transmitting the positioning reference signal.

### (Supplementary Note 9)

The method according to Supplementary note 6, wherein
the transmitting the positioning reference signal is performed across an entire configured bandwidth used for the UE-to-UE direct communication, and the method comprises:
selecting, from the continuous resource, at least one specific resource by performing spectrum sensing, and wherein
the transmitting the positioning reference signal is performed using the at least one specific resource.

### (Supplementary Note 10)

The method according to Supplementary note 6, wherein
the continuous resource indicates a resource pool, and
the transmitting the positioning reference signal is performed using at least one resource included in the resource pool.

### (Supplementary Note 11)

The method according to any of Supplementary notes 6 to 10, wherein the continuous resource is represented by bitmap information.

### (Supplementary Note 12)

A method performed by a network node, the method comprising:
transmitting, to a first user equipment (UE) configured for UE-to-UE direct communication, information identifying a continuous resource in at least one of time domain and frequency domain for transmission of a positioning reference signal for a second UE.

### (Supplementary Note 13)

A method performed by a user equipment (UE), the method comprising:
receiving first configuration information for UE-to-UE direct communication, the first configuration information including information identifying, within a slot, at least one symbol for one or more of a physical sidelink control channel (PSCCH), a physical sidelink feedback channel (PSFCH), at least one automatic gain control (AGC), and at least one guard symbol; and
transmitting the positioning reference signal using one or more other symbol than the at least one symbol based on the first and second configuration information.

### (Supplementary Note 14)

The method according to Supplementary note 13, further comprising:
receiving second configuration information for transmitting a positioning reference signal, wherein the second configuration information identifies an offset, in a number of symbols, for determining a starting symbol to be used for transmitting the positioning reference signal; and
puncturing the positioning reference signal on the at least one symbol.

### (Supplementary Note 15)

The method according to Supplementary note 13, further comprising:
receiving second configuration information for transmitting a positioning reference signal, wherein the second configuration information identifies, based on a maximum number of symbols for the PSCCH, an offset for determining a starting symbol to be used for transmitting the positioning reference signal.

### (Supplementary Note 16)

The method according to Supplementary note 15, wherein the offset is selected from a range having:
a minimum value equal to the maximum number of symbols for the PSCCH plus one; and
a maximum value equal to a total number of symbols in the slot minus a count of the at least one symbol.

### (Supplementary Note 17)

The method according to Supplementary note 13, further comprising:
receiving, via sidelink control information (SCI), second configuration information for transmitting the positioning reference signal over at least one specific symbol in a slot.

### (Supplementary Note 18)

The method according to Supplementary note 17, wherein the positioning reference signal is an aperiodic positioning reference signal.

### (Supplementary Note 19)

A method performed by a network node, the method comprising:
transmitting, to a user equipment (UE), first configuration information for UE-to-UE direct communication, the configuration information including information identifying, within a slot, at least one symbol for one or more of a physical sidelink control channel (PSCCH), a physical sidelink feedback channel (PSFCH), at least one automatic gain control (AGC) symbol, and at least one guard symbol; and
transmitting, to the UE, second configuration information for transmitting a positioning reference signal using one or more other symbol than the at least one symbol.

### (Supplementary Note 20)

A method performed by a network node for positioning of a user equipment (UE) configured for UE-to-UE direct communication, the method comprising:
performing a phase measurement based positioning;
performing at least one other type of positioning; and
determining a location of the UE based on the phase measurement based positioning and the at least one other type of positioning.

### (Supplementary Note 21)

The method according to Supplementary note 20, wherein the at least one other type of positioning includes one or more of:
a positioning based on a timing of a positioning reference signal;
a positioning based on a power of a positioning reference signal;
a positioning based on an angle-of-departure of a positioning reference signal; and
a positioning based on an angle-of-arrival of a positioning reference signal.

### (Supplementary Note 22)

The method according to Supplementary note 20 or 21, wherein the phase measurement based positioning and the at least one other type of positioning use respective positioning reference signal resource sets.

### (Supplementary Note 23)

The method according to Supplementary note 22, wherein the respective positioning reference signal resource sets are mutually exclusive to each other.

### (Supplementary Note 24)

The method according to Supplementary note 22, wherein the respective positioning reference signal resource sets are at least partially overlapping.

### (Supplementary Note 25)

The method according to Supplementary note 24, further comprising:
performing a measurement of arrival time difference for a positioning reference signal in an overlapping set; and
performing a measurement of phase of the positioning reference signal in the overlapping set;
wherein the location of the UE is determined based on the arrival time difference and the phase of the positioning reference signal in the overlapping set.

### (Supplementary Note 26)

A method performed by a user equipment (UE) configured for UE-to-UE direct communication, the method comprising:
receiving information identifying at least one period associated with the UE for muting transmission of a positioning reference signal by the UE, wherein the period is defined on a symbol or slot level.

### (Supplementary Note 27)

The method according to Supplementary note 26, wherein the information identifies the at least one period based on a pattern.

### (Supplementary Note 28)

The method according to Supplementary note 26 or 27, wherein the at least one period associated with the UE is different to a further at least one period associated with a further UE.

### (Supplementary Note 29)

The method according to Supplementary note 26, wherein the at least one period associated with the UE is based on a random pattern.

### (Supplementary Note 30)

The method according to any of Supplementary notes 26 to 29, wherein
the at least one period associated with the UE is applicable when transmissions by a serving or adjacent base station are muted; and
the method further comprises transmitting a positioning reference signal in the at least one period associated with the UE, in a case that transmissions by the serving or adjacent base station are muted.

### (Supplementary Note 31)

The method according to any of Supplementary notes 26 to 29, further comprising transmitting a positioning reference signal in the at least one period associated with the UE, regardless whether transmissions by a serving or adjacent base station are muted or not.

### (Supplementary Note 32)

A method performed by a network node, the method comprising:
transmitting, to a user equipment (UE) configured for UE-to-UE direct communication, information identifying at least one period associated with the UE for muting transmission of a positioning reference signal by the UE, wherein the period is defined on a symbol or slot level.

### (Supplementary Note 33)

A method performed by a user equipment (UE) configured for UE-to-UE direct communication, the method comprising:
performing a plurality of measurements based on respective positioning reference signals transmitted by a plurality of anchor UEs;
transmitting, to a network node, results of the plurality of measurements and respective identifiers associated with the anchor UEs to which the results relate; and
receiving, from the network node, at least one of the respective identifiers indicating one or more anchor UE to be used in determining a current location of the UE.

### (Supplementary Note 34)

A method performed by a network node, the method comprising:
receiving, from a user equipment (UE) configured for UE-to-UE direct communication, results of a plurality of measurements based on respective positioning reference signals transmitted by a plurality of anchor UEs and respective identifiers associated with the anchor UEs to which the results relate; and
transmitting, to the UE, at least one of the respective identifiers indicating one or more anchor UE to be used in determining a current location of the UE.

### (Supplementary Note 35)

The method according to Supplementary note 34, further comprising:
selecting the one or more anchor UE to be used in determining a current location of the UE based on at least one criterion.

### (Supplementary Note 36)

A method performed by a user equipment (UE) configured for UE-to-UE direct communication, the method comprising:
receiving, from an anchor UE, at least one of information indicating whether a location of the anchor UE is available and information indicating whether the anchor UE can be used for positioning; and
transmitting a request to the anchor UE for determining a current location of the UE in a case that the location of the anchor UE is available and the anchor UE can be used for positioning.

### (Supplementary Note 37)

The method according to Supplementary note 36, further comprising:
receiving, from each one of a plurality of anchor UEs, respective information indicating whether a location of the one of the plurality of anchor UEs is available; and
selecting one or more of the plurality of anchor UEs, based on at least one criterion, for determining the current location of the UE.

### (Supplementary Note 38)

The method according to Supplementary note 35 or 37, wherein the at least one criterion includes one or more of:
a location availability criterion;
a velocity criterion;
a received signal power criterion; and
a received signal quality criterion.

### (Supplementary Note 39)

The method according to any of Supplementary notes 12, 19 to 25, and 32 to 35, wherein the network node is a base station.

### (Supplementary Note 40)

The method according to any of Supplementary notes 20 to 25, wherein the network node is the UE.

### (Supplementary Note 41)

The method according to any of Supplementary notes 32 to 35, wherein the network node is a positioning function entity.

### (Supplementary Note 42)

A network node comprising:
means for receiving, periodically or on-demand, location information of a user equipment (UE) configured for UE-to-UE direct communication and chosen as an anchor UE;
means for receiving, periodically or on-demand, assistance information indicating at least one characteristic relating to a change of a location of the anchor UE; and
means for using the location information and the assistance information in a procedure for determining a location of a target UE.

### (Supplementary Note 43)

A user equipment (UE) configured for UE-to-UE direct communication and chosen as an anchor UE, the UE comprising:
means for transmitting, to a network node, location information of the UE and assistance information indicating at least one characteristic relating to a change in a location of the UE, for use by the network node in a procedure for determining a location of a target UE.

### (Supplementary Note 44)

A first user equipment (UE) configured for UE-to-UE direct communication, the first UE comprising:
means for receiving, from a network node, information identifying a continuous resource for transmission of a positioning reference signal for a second UE; and
means for transmitting the positioning reference signal using the continuous resource.

### (Supplementary Note 45)

A network node comprising:
means for transmitting, to a first user equipment (UE) configured for UE-to-UE direct communication, information identifying a continuous resource in at least one of time domain and frequency domain for transmission of a positioning reference signal for a second UE.

### (Supplementary Note 46)

A user equipment (UE) comprising:
means for receiving first configuration information for UE-to-UE direct communication, the first configuration information including information identifying, within a slot, at least one symbol for one or more of a physical sidelink control channel (PSCCH), a physical sidelink feedback channel (PSFCH), at least one automatic gain control (AGC), and at least one guard symbol; and
means for transmitting the positioning reference signal using one or more other symbol than the at least one symbol based on the first and second configuration information.

### (Supplementary Note 47)

A network node comprising:
means for transmitting, to a user equipment (UE), first configuration information for UE-to-UE direct communication, the configuration information including information identifying, within a slot, at least one symbol for one or more of a physical sidelink control channel (PSCCH), a physical sidelink feedback channel (PSFCH), at least one automatic gain control (AGC) symbol, and at least one guard symbol; and
transmitting, to the UE, second configuration information for transmitting a positioning reference signal using one or more other symbol than the at least one symbol.

### (Supplementary Note 48)

A network node for positioning of a user equipment (UE) configured for UE-to-UE direct communication, the network node comprising:
means for performing a phase measurement based positioning;
means for performing at least one other type of positioning; and
means for determining a location of the UE based on the phase measurement based positioning and the at least one other type of positioning.

### (Supplementary Note 49)

A user equipment (UE) configured for UE-to-UE direct communication, the UE comprising:
means for receiving information identifying at least one period associated with the UE for muting transmission of a positioning reference signal by the UE, wherein the period is defined on a symbol or slot level.

### (Supplementary Note 50)

A network node comprising:
means for transmitting, to a user equipment (UE) configured for UE-to-UE direct communication, information identifying at least one period associated with the UE for muting transmission of a positioning reference signal by the UE, wherein the period is defined on a symbol or slot level.

### (Supplementary Note 51)

A user equipment (UE) configured for UE-to-UE direct communication, the UE comprising:
means for performing a plurality of measurements based on respective positioning reference signals transmitted by a plurality of anchor UEs;
means for transmitting, to a network node, results of the plurality of measurements and respective identifiers associated with the anchor UEs to which the results relate; and
means for receiving, from the network node, at least one of the respective identifiers indicating one or more anchor UE to be used in determining a current location of the UE.

### (Supplementary Note 52)

A network node comprising:
means for receiving, from a user equipment (UE) configured for UE-to-UE direct communication, results of a plurality of measurements based on respective positioning reference signals transmitted by a plurality of anchor UEs and respective identifiers associated with the anchor UEs to which the results relate; and
means for transmitting, to the UE, at least one of the respective identifiers indicating one or more anchor UE to be used in determining a current location of the UE.

### (Supplementary Note 53)

A user equipment (UE) configured for UE-to-UE direct communication, the UE comprising:
means for receiving, from an anchor UE, at least one of information indicating whether a location of the anchor UE is available and information indicating whether the anchor UE can be used for positioning; and
means for transmitting a request to the anchor UE for determining a current location of the UE in a case that the location of the anchor UE is available and the anchor UE can be used for positioning.

### REFERENCE SIGNS LIST

1 Telecommunication system
3, 3A, 3B Mobile device, UE
5 Base station, (R) AN node
7 Core network
10 Control Plane Function (CPF)
11 User Plane Function (UPF)
12 Location Management Function (LMF)
20 Data network
31 Transceiver circuit
33 Antenna
35 User interface
37 Controller
39 Memory
41 Operating system
43 Communications control module
45 Direct communications module
47 Positioning module
51 Transceiver circuit
53 Antenna
55 Network interface
57 Controller
59 Memory
61 Operating system
63 Communications control module
71 Transceiver circuit
75 Network interface
77 Controller
79 Memory
81 Operating system
83 Communications control module
87 Location management module

What is claimed is:

1-51. (canceled)

52. A method performed by a user equipment (UE) configured for UE-to-UE direct communication, the method comprising:
receiving, from a network node, information for determining a resource for transmitting a positioning reference signal for another UE; and
transmitting the positioning reference signal using a resource which is determined based on using the information, wherein
the information includes first configuration information indicating, within a slot, at least one symbol for one or more of a physical sidelink control channel (PSCCH), a physical sidelink feedback channel (PSFCH), at least one automatic gain control (AGC), and at least one guard symbol, and
the transmitting is performed by transmitting the positioning reference signal using one or more other symbol than the at least one symbol based on the information.

53. The method according to claim 52, further comprising:
receiving second configuration information indicating an offset, in a number of symbols, for determining a starting symbol to be used for transmitting the positioning reference signal, and wherein
the transmitting is performed by transmitting the positioning reference signal using the starting symbol and symbols later than the starting symbol.

54. The method according to claim 53, wherein
symbols corresponding to the number of symbols before the starting symbol are for one or more of a PSCCH, a PSFCH, at least one AGC, and at least one guard symbol.

55. The method according to claim 52, further comprising:
receiving second configuration information indicating, based on a maximum number of symbols for the PSCCH, an offset for determining a starting symbol to be used for transmitting the positioning reference signal.

56. The method according to claim 55, wherein the offset is selected from a range having:
a minimum value equal to the maximum number of symbols for the PSCCH plus one; and
a maximum value equal to a total number of symbols in the slot minus a count of the at least one symbol.

57. The method according to claim 52, further comprising:
receiving, via sidelink control information (SCI), second configuration information for transmitting the positioning reference signal over at least one specific symbol in the slot, and wherein
the positioning reference signal is an aperiodic positioning reference signal.

58. The method according to claim 52, wherein
the information indicates a continuous resource for the transmission of the positioning reference signal for the another UE.

59. The method according to claim 58, wherein
the continuous resource corresponds to at least a part of a resource pool, and
the transmitting the positioning reference signal is performed using the at least the part of the resource pool.

60. The method according to claim 58, wherein
the transmitting the positioning reference signal is performed across an entire configured bandwidth used for the UE-to-UE direct communication, and
the information indicates a time period for transmitting the positioning reference signal.

61. The method according to claim 58, wherein
the transmitting the positioning reference signal is performed across an entire configured bandwidth used for the UE-to-UE direct communication, and
the transmitting the positioning reference signal is performed using a common part of the continuous resource and a specific resource pool for transmitting the positioning reference signal.

62. The method according to claim 58, wherein
the transmitting the positioning reference signal is performed across an entire configured bandwidth used for the UE-to-UE direct communication, and the method comprises:
selecting, from the continuous resource, at least one specific resource by performing spectrum sensing, and wherein
the transmitting the positioning reference signal is performed using the at least one specific resource.

63. The method according to claim 58, wherein
the continuous resource is represented by bitmap information.

64. The method according to claim 52, wherein
the information indicates at least one period corresponding to the UE for muting transmission of the positioning reference signal by the UE, and
the period is defined on a symbol or slot level.

65. The method according to claim 64, wherein the at least one period is different from a further at least one period corresponding to the another UE.

66. The method according to claim 64, wherein
the at least one period is applicable in a case where transmission by a serving or adjacent network node is muted, and
the transmitting is performed by transmitting the positioning reference signal in the at least one period, in a case where transmission by the serving or adjacent network node is muted.

67. The method according to claim 64, wherein
the transmitting is performed by transmitting the positioning reference signal in the at least one period, regardless of whether transmission by a serving or adjacent network node is muted or not.

68. The method according to claim 52, wherein the network node is a base station or the UE.

69. A method performed by a network node, the method comprising:
transmitting, to a user equipment (UE) configured for UE-to-UE direct communication, information for use by the UE in determining a resource for transmitting a positioning reference signal for another UE, wherein
the information includes first configuration information indicating, within a slot, at least one symbol for one or more of a physical sidelink control channel (PSCCH), a physical sidelink feedback channel (PSFCH), at least one automatic gain control (AGC), and at least one guard symbol, and
the positioning reference signal is transmitted, by the UE, using one or more other symbol than the at least one symbol based on the information.

70. A user equipment (UE) configured for UE-to-UE direct communication, the UE comprising:
a memory storing instructions; and
at least one processor configured to process the instructions to:
receive, from a network node, information for determining a resource for transmitting a positioning reference signal for another UE; and
transmit the positioning reference signal using a resource which is determined based on using the information, wherein
the information includes first configuration information indicating, within a slot, at least one symbol for one or more of a physical sidelink control channel (PSCCH), a physical sidelink feedback channel (PSFCH), at least one automatic gain control (AGC), and at least one guard symbol, and
the at least one processor is further configured to process the instructions to transmit the positioning reference signal using one or more other symbol than the at least one symbol based on the information.

71. A network node comprising:
a memory storing instructions; and
at least one processor configured to process the instructions to:
transmit, to a user equipment (UE) configured for UE-to-UE direct communication, information for use by the UE in determining a resource for transmitting a positioning reference signal for another UE, wherein
the information includes first configuration information indicating, within a slot, at least one symbol for one or more of a physical sidelink control channel (PSCCH), a physical sidelink feedback channel (PSFCH), at least one automatic gain control (AGC), and at least one guard symbol, and
the positioning reference signal is transmitted, by the UE, using one or more other symbol than the at least one symbol based on the information.
